(19) United States
(12) Patent Application Publication
(10) Pub. No.: US 2020/0207572 A1
(43) Pub. Date: Jul. 2, 2020

(54) SYSTEM AND METHOD FOR ASSIGNING ELEVATOR SERVICE BASED ON A DETECTED NUMBER OF PASSENGERS

(71) Applicant: OTIS ELEVATOR COMPANY, Farmington, CT (US)

(72) Inventors: KMSreekanth Jarugubilli, Hyderabad (IN); Naveen Kumar Yeddi, Hyderabad (IN)

(21) Appl. No.: 16/722,837

(22) Filed: Dec. 20, 2019

(30) Foreign Application Priority Data
Dec. 28, 2018 (IN) 201811049531

(51) Int. Cl. B66B 1/24; B66B 3/00; B66B 5/00; B66B 1/34; B66B 1/46

(52) U.S. Cl. CPC B66B 1/2408; B66B 3/002; B66B 5/0012; B66B 2201/215; B66B 1/468; B66B 1/2458; B66B 1/3461

(57) ABSTRACT

Disclosed is an elevator system having a controller configured for: rendering a first determination that an elevator service call is placed at a first lobby, rendering a second determination that captured video data indicates a plurality of passengers including a first passenger is at the first lobby, and executing a first communication to instruct a first elevator car to effect elevator service at the first lobby based on the first determination and the second determination.

### CROSS-REFERENCE TO RELATED APPLICATION

This application claims the benefit of Indian Application No. 201811049531 filed Dec. 28, 2018, the disclosure of which is incorporated herein by reference in its entirety.

### BACKGROUND

The embodiments herein relate to elevator systems and more specifically to a system and method for assigning elevator service based on a detected number of passengers.

At an elevator lobby, there may be a circumstance where a number of people waiting for elevator service exceeds a capacity of an elevator car. Passenger waiting times may increase while ridership convenience decreases.

### BRIEF SUMMARY

Disclosed is an elevator system comprising a controller configured for: rendering a first determination that an elevator service call is placed at a first lobby, rendering a second determination that captured video data indicates a plurality of passengers including a first passenger is at the first lobby, and executing a first communication to instruct a first elevator car to effect elevator service at the first lobby based on the first determination and the second determination.

The system of claim 1 wherein the controller is configured for: executing a second communication instructing a first panel at the first lobby to display information indicating that the first elevator car is assigned to effect elevator service at the first lobby.

In addition to one or more of the above disclosed features or as an alternate the controller is configured for: executing a third communication instructing the first panel to display information indicating a time of arrival for the first elevator car.

In addition to one or more of the above disclosed features or as an alternate the controller is configured for: rendering a third determination that the first video data includes a number of shapes at the first lobby, rendering a fourth determination that the number of detected shapes corresponds with a count of people at the first lobby, and rendering a fifth determination that the count of people corresponds with the plurality of passengers.

In addition to one or more of the above disclosed features or as an alternate the controller is configured for: executing a fourth communication instructing the panel to display the count of people at the first lobby that are receiving elevator service with the first elevator car.

In addition to one or more of the above disclosed features or as an alternate the controller is configured for: rendering a sixth determination that a first capacity for the first elevator car is exceeded by the count of people at the first lobby, and executing a fifth communication to instruct a plurality of elevator cars, including the first elevator car, to effect elevator service at the first lobby.

In addition to one or more of the above disclosed features or as an alternate the controller is configured for: executing a sixth communication of instructing the first panel to display information indicating that the plurality of elevator cars is assigned to effect elevator service at the first lobby.

In addition to one or more of the above disclosed features or as an alternate, when the first capacity for the first elevator car is exceeded by the number of detected people at the first lobby, the controller is configured for: executing a seventh communication instructing the first panel to display information indicating the time of arrival for the plurality of elevator cars.

In addition to one or more of the above disclosed features or as an alternate the controller is configured for: executing an eighth communication of instructing the panel to display the number of people detected at the first lobby that are receiving elevator service with each of the plurality of elevator cars.

In addition to one or more of the above disclosed features or as an alternate the controller communicates with the elevator cars and the panel over a CAN network.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 illustrates implements of an elevator system that may employ various embodiments of the present disclosure; and

FIGS. 3-6 illustrate various process steps that may be employed by embodiments of the present disclosure.

### DETAILED DESCRIPTION

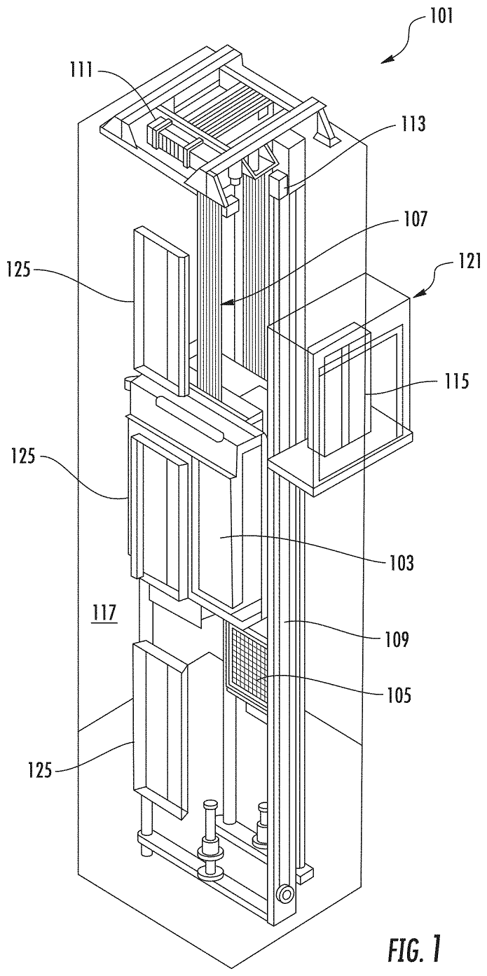

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counter weight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

The following figures illustrate additional technical features associated with one or more disclosed embodiments. Features disclosed in the following figures having nomenclature similar to features disclosed in FIG. 1 may be similarly construed though being positively reintroduced with numerical identifiers that may differ from those in FIG. 1. Further, process steps disclosed herein may be sequentially numbered to facilitate discussion of one or more disclosed embodiments. Thus, a set of steps having an initial range may include subsequently introduced steps having numbers that are sequentially outside the initial range. Such numbering is not intended to identify a specific sequence of performing such steps or a specific requirement to perform such steps unless expressly indicated.

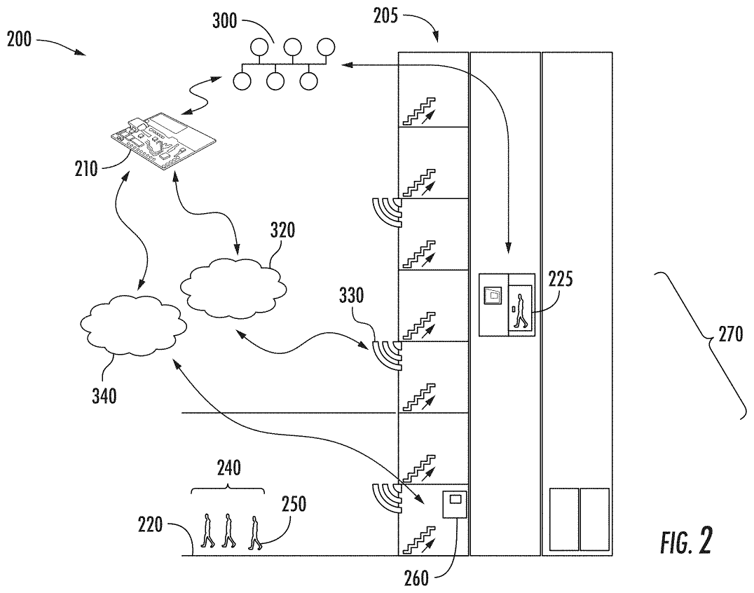

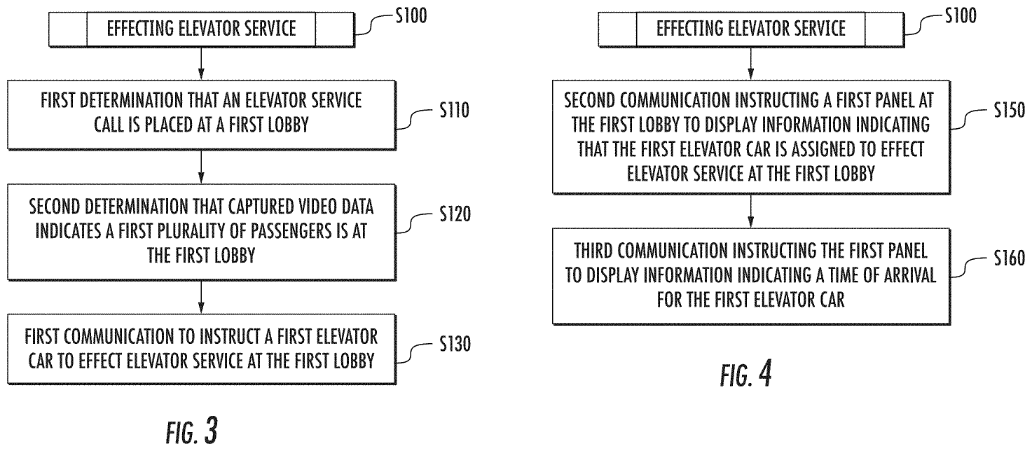

Turning to FIGS. 2 and 3, disclosed is an elevator system 200 in a building 205. The system 200 comprises a controller 210. The controller 210 is configured for executing step S100 of effecting elevator service which includes rendering a plurality of determinations and executing one or more communications. Step at step S110 the controller may render a first determination that an elevator service call is placed at a first lobby 220. At step S120 the controller may render a second determination that captured video data indicates a plurality of passengers 240 including a first passenger 250 is at the first lobby 220. At step S130 the controller 210 may executes a first communication to instruct a first elevator car 225 to effect elevator service at the first lobby 220.

Turning to FIG. 4, at step S150 the controller 210 is further configured for executing a second communication instructing a first display panel 260 at the first lobby 220 to display information indicating that the first elevator car 225 is assigned to effect elevator service at the first lobby 220. At step S160 the controller 210 is configured for executing a third communication instructing the first panel 260 to display information indicating a time of arrival for the first elevator car 225 at the first lobby 220.

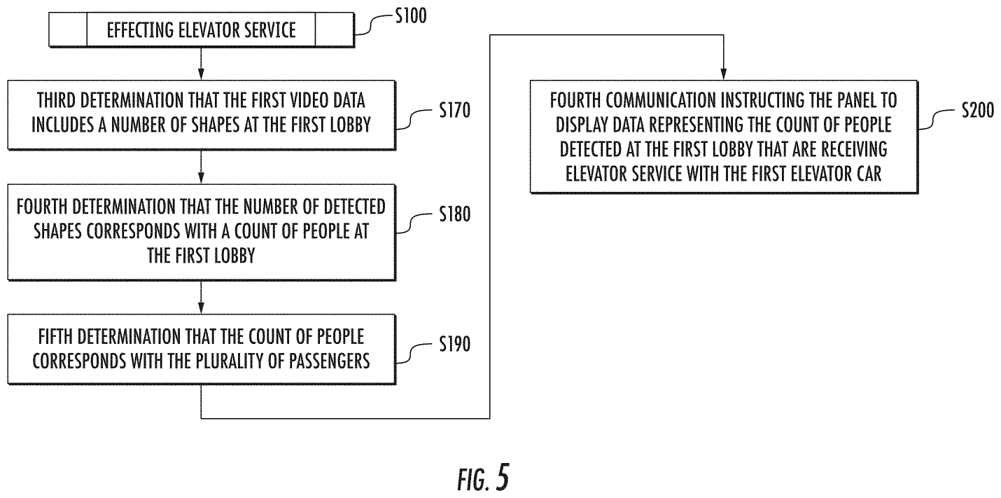

As illustrated in FIG. 5, at step S170 the controller 210 is configured for rendering a third determination that the first video data includes a number of shapes at the first lobby 220. At step S180 the controller 210 may render a fourth determination that the number of detected shapes corresponds with a count of people at the first lobby 220. At step S190 the controller 210 may render a fifth determination that the count of people corresponds with the plurality of passengers 240. At step S200 the controller 210 may be configured for executing a fourth communication instructing the display panel 260 to display data representing a count of the number of people detected at the first lobby 220 that are receiving elevator service with the first elevator car 225.

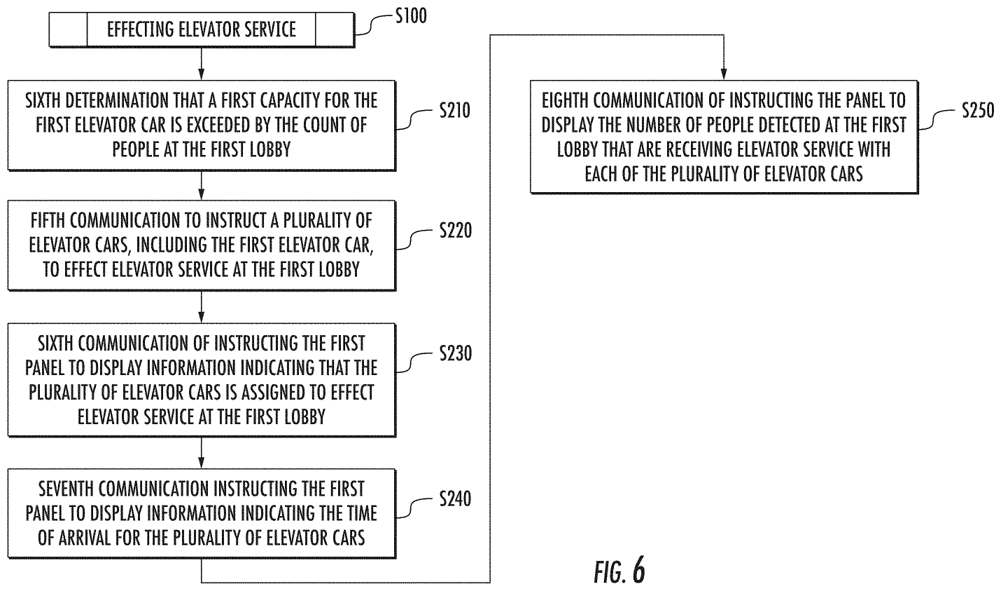

As illustrated in FIG. 6, at step S210 the controller 210 is figured for rendering a sixth determination that a first capacity for the first elevator car is exceeded by the count of people at the first lobby 220. At step S220, the controller 210 execute a fifth communication to instruct a plurality of elevator cars 270, including the first elevator car 225, to effect elevator service at the first lobby 220. At step S230 the controller 210 is configured for executing a sixth communication of instructing the first panel 260 to display information indicating that the plurality of elevator cars 270 is assigned to effect elevator service at the first lobby 220. At step S240 the controller 210 is configured for executing a seventh communication instructing the first panel 260 to display information indicating the time of arrival for the plurality of elevator cars 270. At step S250 the controller 210 is configured for executing an eighth communication of instructing the panel 260 to display the number of people detected at the first lobby 220 that are receiving elevator service with each of the plurality of elevator cars 270.

The controller 210 may communicate with the first elevator car 225 over a controller area network (CAN) 300. In addition the controller 210 may communicate with a mobile device 310 for the first passenger 250 as may be needed, for example to communicate elevator assignment information, over a personal area network (PAN) 320 over a network beacon 330. The controller may communicate with the panel 260 over a local area network (LAN) 340. The CAN 300, PAN 320 and LAN 340 networks are examples of suitable networks; it is understood that other network topologies may be used in the elevator system 200.

In the above disclosed embodiments when an elevator call is executed at an elevator lobby, the system detects a passenger count using video data. The video data, for example, is obtained using a three dimensional (3D) stereoscope camera disposed in the lobby. Obtain data may be is processed with machine learning (ML) analytics to obtain an approximate people count. Based on a people count and an elevator capacity, the system may predict a number of elevators needed to effect elevator service. The system instruct a display in the lobby to identify a passenger count, a number of elevator cars dispatched to effect elevator service at the first lobby, and a waiting time for elevator service. The disclosed embodiments may help to reduce wait time for elevator service.

As used herein an elevator controller and/or elevator group controller (EGC) may be a microprocessor based controller that controls many aspects of the elevator operation. A series of sensors, controllers, sequences of operation and real-time calculations or algorithms that balance passenger demand and car availability. Elevator sensors may provide data on car positions, car moving direction, loads, door status, hall calls, car calls, pending up hall and down hall calls, number of runs per car, alarms, etc. The controllers may also have a function enabling the testing the systems without shutdown of the elevator. From collected data, a management system consisting of a workstation and software applications that may create metrics for a group or particular car such as total number of door openings, number of runs per car or call, up and down hall calls, etc. Some performance indicators may be related to passenger wait times and/or elevator car travel times. These metrics may indicate inadequate controls, misconfiguration or even equipment malfunction. Elevator monitoring may be provided as Software as a Service (SaaS). The monitoring may identify malfunctions or abnormal operating parameters and automatically dispatch a technician and/or provide alerts to relevant persons such as building owners. Some systems may provide customer dashboards accessible via a web browser and/or provide owners with information such as performance summaries and maintenance histories. As indicated, the elevator controller may communicate with the one or more elevators over a Controller Area Network (CAN) bus. A CAN is a vehicle bus standard that allow microcontrollers and devices to communicate with each other in applications without a host computer. CAN is a message-based protocol released by the International Organization for Standards (ISO). Downstream communications from the elevator system controller may be over a LAN.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. An elevator system comprising a controller configured for:
rendering a first determination that an elevator service call is placed at a first lobby,
rendering a second determination that captured video data indicates a plurality of passengers including a first passenger is at the first lobby, and
executing a first communication to instruct a first elevator car to effect elevator service at the first lobby based on the first determination and the second determination.

2. The system of claim 1 wherein the controller is configured for:
executing a second communication instructing a first panel at the first lobby to display information indicating that the first elevator car is assigned to effect elevator service at the first lobby.

3. The system of claim 2 wherein the controller is configured for:
executing a third communication instructing the first panel to display information indicating a time of arrival for the first elevator car.

4. The system of claim 3 wherein the controller is configured for:
rendering a third determination that the first video data includes a number of shapes at the first lobby,
rendering a fourth determination that the number of detected shapes corresponds with a count of people at the first lobby, and
rendering a fifth determination that the count of people corresponds with the plurality of passengers.

5. The system of claim 4 when the controller is configured for:
executing a fourth communication instructing the panel to display the count of people at the first lobby that are receiving elevator service with the first elevator car.

6. The system of claim 5 wherein the controller is configured for:
rendering a sixth determination that a first capacity for the first elevator car is exceeded by the count of people at the first lobby, and
executing a fifth communication to instruct a plurality of elevator cars, including the first elevator car, to effect elevator service at the first lobby.

7. The system of claim 6 wherein the controller is configured for:
executing a sixth communication of instructing the first panel to display information indicating that the plurality of elevator cars is assigned to effect elevator service at the first lobby.

8. The system of claim 7 wherein, when the first capacity for the first elevator car is exceeded by the number of detected people at the first lobby, the controller is configured for:
executing a seventh communication instructing the first panel to display information indicating the time of arrival for the plurality of elevator cars.

9. The system of claim 8 wherein the controller is configured for:
executing an eighth communication of instructing the panel to display the number of people detected at the first lobby that are receiving elevator service with each of the plurality of elevator cars.

10. The system of claim 9 wherein the controller communicates with the elevator cars and the panel over a CAN network.

11. A method for controlling an elevator system with a system controller, the method comprising:
rendering a first determination that an elevator service call is placed at a first lobby,
rendering a second determination that captured video data indicates a plurality of passengers including a first passenger is at the first lobby, and
executing a first communication to instruct a first elevator car to effect elevator service at the first lobby based on the first determination and the second determination.

12. The method of claim 11 wherein the controller is configured for:
executing a second communication instructing a first panel at the first lobby to display information indicating that the first elevator car is assigned to effect elevator service at the first lobby.

13. The method of claim 12 wherein the controller is configured for:
executing a third communication instructing the first panel to display information indicating a time of arrival for the first elevator car.

14. The method of claim 13 wherein the controller is configured for:
rendering a third determination that the first video data includes a number of shapes at the first lobby,
rendering a fourth determination that the number of detected shapes corresponds with a count of people at the first lobby, and
rendering a fifth determination that the count of people corresponds with the plurality of passengers.

15. The method of claim 14 when the controller is configured for:
executing a fourth communication instructing the panel to display the count of people at the first lobby that are receiving elevator service with the first elevator car.

16. The method of claim 15 wherein the controller is configured for:
rendering a sixth determination that a first capacity for the first elevator car is exceeded by the count of people at the first lobby, and
executing a fifth communication to instruct a plurality of elevator cars, including the first elevator car, to effect elevator service at the first lobby.

17. The method of claim 16 wherein the controller is configured for:
executing a sixth communication of instructing the first panel to display information indicating that the plurality of elevator cars is assigned to effect elevator service at the first lobby.

18. The method of claim 17 wherein, when the first capacity for the first elevator car is exceeded by the number of detected people at the first lobby, the controller is configured for:
executing a seventh communication instructing the first panel to display information indicating the time of arrival for the plurality of elevator cars.

19. The method of claim 18 wherein the controller is configured for:
executing an eighth communication of instructing the panel to display the number of people detected at the first lobby that are receiving elevator service with each of the plurality of elevator cars.

20. The method of claim 19 wherein the controller communicates with the elevator cars and the panel over a CAN network.
